(19) United States
(12) Patent Application Publication
(10) Pub. No.: US 2018/0201054 A1
(43) Pub. Date: Jul. 19, 2018

(54) DECORATIVE PART AND METHOD FOR THE PRODUCTION OF A DECORATIVE PART

(71) Applicant: Dr. Ing. h.c.F. Porsche Aktiengesellschaft, Stuttgart (DE)

(72) Inventor: Volker Sieber, Karlsbad (DE)

(21) Appl. No.: 15/867,752

(22) Filed: Jan. 11, 2018

(30) Foreign Application Priority Data
Jan. 16, 2017 (DE) 102017100691.5

(51) Int. Cl. B44C 5/04; B05D 7/06; B44C 3/10; B27D 1/00; B60R 13/02

(52) U.S. Cl. CPC B44C 5/0415; B05D 7/06; B60R 13/02; B44C 3/10; B27D 1/00; B44C 5/043

(57) ABSTRACT

A decorative part for an interior trim of a motor vehicle includes a wood veneer, wherein the wood veneer has depressions, which are introduced by stamping. The depressions are filled with a hardened metal paste, wherein the hardened metal paste is provided exclusively in the depressions.

### CROSS REFERENCE TO RELATED APPLICATIONS

This application claims benefit to German Patent Application No. DE 10 2017 100 691.5, filed Jan. 16, 2017.

### FIELD

The invention relates to a decorative part with the aid of which an interior trim of a motor vehicle can be formed and to a method for the production of a decorative part of this kind.

### BACKGROUND

For the optical effect of a decorative part of an interior trim of a motor vehicle, DE 197 54 420 C1 discloses the practice of stamping a wood veneer and filling the stamped and partially colored impressions with a clear lacquer.

If a decorative part of an interior trim of a motor vehicle is to be provided with a metallic appearance, there is a known practice of introducing into a wood veneer a depression corresponding to the metallic appearance and of inserting a pre-produced metal lesene or metal die corresponding to the shape of the depression into said depression.

### SUMMARY

In an embodiment, the present invention provides a decorative part for an interior trim of a motor vehicle. The decorative part includes a wood veneer, wherein the wood veneer has depression filled with a hardened metal paste, wherein the hardened metal paste is provided exclusively in the depressions.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic sectional view of a decorative part at a first production time;

FIG. 2 shows a schematic sectional view of the decorative part from FIG. 1 at a later, second production time;

FIG. 3 shows a schematic sectional view of the decorative part from FIG. 2 at a later, third production time;

FIG. 4 shows a schematic sectional view of the decorative part from FIG. 3 at a later, fourth production time; and

FIG. 5 shows a schematic sectional view of the decorative part from FIG. 4 at a later, fifth production time.

### DETAILED DESCRIPTION

There is a constant demand for the ability to provide a decorative part for an interior trim of a motor vehicle with a particularly fine metallic appearance.

Embodiments of the invention provide decorative parts for an interior trim of a motor vehicle having a particularly fine metallic appearance.

According to an embodiment of the invention, a decorative part for an interior trim of a motor vehicle is provided, having a wood veneer, wherein the wood veneer has depressions, which, in particular, are introduced by stamping, wherein the depressions are filled with a hardened metal paste, wherein the hardened metal paste is provided exclusively in the depressions.

By virtue of its rather pasty consistency, the metal paste can be introduced easily into the depressions and adapted to the contours of the depressions. In contrast to the introduction of metal lesenes or pre-produced metal bodies into the depressions, the metal paste can automatically fill and compensate for a gap which would otherwise be formed between the metallic material and the wood veneer. Production tolerances can be compensated automatically by the metal paste. The metal paste can be applied by spraying and/or putty knife, for example, so that the depressions are filled. Excess metal paste can be wiped away afterwards, for example, leaving metal paste only in the depressions, and this can then harden. Intermediate regions of the wood veneer which are situated outside the depressions are substantially free from metal paste. Alternatively, the metal paste can first harden and then be removed from the intermediate regions, e.g. by machining. This leads to very high dimensional accuracy and edge sharpness of the metallic material introduced into the wood veneer, which would not be possible in this quality when using a metal insert. In particular, it is also possible to achieve very complex and particularly fine metallic regions in the wood veneer, thus making it possible to provide small metallic ornaments in the decorative part without problems. By means of the metal paste, which can be adapted easily to the possibly very complex and/or fine configuration of the depressions, a decorative part for an interior trim of a motor vehicle with a particularly fine metallic appearance can be made possible.

By way of example, a line width b of the metal paste hardened in the depressions can be b≤1.0 mm, in particular b≤0.8 mm, preferably b≤0.5 mm and particularly preferably b≤0.3 mm, wherein b≥0.25 mm is preferred, to ensure that the metallic region is still readily visible in the decorative part. The metal paste can be, for example, a suspension of a, preferably pasty, binder, which is laden with metal powder and/or metal flakes. In particular, the suspension can contain a plasticizer, which can evaporate due to the introduction of heat, for example. In particular, the binder and/or the plasticizer are substantially transparent, with the result that the appearance of the metal paste is determined substantially by the metal in the metal paste. Once a sufficient proportion of the plasticizer has evaporated from the metal paste, the binder can harden and change from a rather pasty state to a rather solid state. Suitable metal pastes are known, for example, from applications for the production of fine conductor tracks in microchips, e.g. as described in EP 2 638 991 A1.

In particular, the hardened metal paste is configured in such a way that the surface thereof is flush with an intermediate region, provided between the depressions, of the wood veneer. This results in a substantially level surface for the decorative part, which can lead to a high-quality haptic effect. In particular, it is possible to avoid offsets and/or gaps and/or joints at the phase boundary between the metal paste and the wood veneer.

The wood veneer preferably has a separating coat for the removal of metal paste from the wood veneer in an intermediate region provided between the depressions. The separating coat can lead to easy removal of the metal paste from the wood veneer surface formed by the separating coat without accidental damage to the surface of the wood veneer during this process. In particular, the metal paste is insoluble in the separating coat. The separating coat furthermore makes it possible to prevent a situation where the metal paste penetrates into pores of the wood veneer and cannot be removed completely or at least can be removed only with difficulty from the intermediate region. The pores of the wood veneer are preferably filled in the intermediate region by the separating coat. The separating coat can contain a pigment, making it possible to adjust the color of the wood veneer. The separating coat is preferably substantially transparent, thus allowing the natural color of the wood veneer to show through. The separating coat is produced from a lacquer, for example.

As a particular preference, the wood veneer is compressed. The density of the wood veneer can be greater than the naturally occurring density if the material thickness of the wood veneer is reduced in a compression step. Cavities and pores in the wood veneer can thereby be reduced. In addition, the wood veneer can have a higher stability. In particular, the depressions are produced by stamping, wherein compression of the wood veneer has taken place simultaneously with the stamping.

In particular, the wood veneer is joined to a three-dimensionally shaped rigid carrier part. The wood veneer can be adhesively bonded to the carrier part, for example. For this purpose, the carrier part can be designed to dissipate forces occurring during operation. The carrier part can be backed by the wood veneer on an outer side. Through the joining of the rather flexible wood veneer to the carrier part, it is possible to fix a three-dimensional configuration of the wood veneer and to define the shape of the decorative part.

Embodiments of the invention further provide methods for producing a decorative part, which, in particular, can be embodied and refined as described above, in which depressions are introduced into a wood veneer, at least the depressions are completely filled with a metal paste, excess metal paste outside the depressions is removed, in particular by machining, and the metal paste provided in the depressions is hardened. By means of the metal paste, which can be adapted easily to the possibly very complex and/or fine configuration of the depressions, a decorative part for an interior trim of a motor vehicle with a particularly fine metallic appearance can be made possible.

The metal paste can be removed while it is still rather pasty by wiping and/or scraping off the excess metal paste, for example. As an alternative, it is possible for the metal paste to harden first and then to be removed in the hardened state, in particular by machining, thereby making it possible, if required, to avoid impairments of the surface finish of the decorative part due to shrinkage effects of the metal paste during hardening. The time sequence of the method steps of removing the metal paste and hardening of the metal paste can thus differ according to the use.

In particular, the depressions are introduced by stamping, in particular with the aid of a stamping roll and/or by means of a stamping punch, wherein, in particular, the wood veneer is compressed to a smaller material thickness during stamping. By means of stamping, particularly fine and complex structures of depressions can be introduced into the wood veneer. At the same time, it is possible to use the pressure which occurs during stamping to compress the wood veneer. For this purpose, it is possible, for example, to provide a flat counter plate, which can engage on the lower side of the wood veneer facing away from the depressions to be produced. The stamping roll and/or the stamping punch can have a positive shape for the depressions to be introduced, which can be produced with a very high accuracy by milling, erosion and/or laser shaping, for example.

The wood veneer is preferably coated with a separating coat for the removal of metal paste from the wood veneer before the depressions are introduced, wherein the separating coat is penetrated in the region of the depressions as the depressions are introduced. The separating coat can be damaged in the region of the depressions by the introduction of the depressions to the extent that the metal paste can penetrate easily into the depressions and, in particular, can bond with the depression flanks, which are not coated with the separating coat. In the intermediate region between the depressions, the separating coat remains undamaged, thus allowing the metal paste to be removed easily in the intermediate region.

As a particular preference, the separating coat is completely or partially removed in an intermediate region provided between the depressions during the removal of the excess metal paste. If at least some of the separating coat is likewise removed during the removal of the metal paste, it is possible to ensure that the metal paste can be removed substantially without residues in the intermediate region. Particularly if some of the separating coat is supposed to remain, e.g. as protection for the surface of the wood veneer and/or for changing the color of the appearance of the wood veneer, a sufficiently large layer thickness can be provided for the separating coat.

In particular, the wood veneer is joined to a three-dimensionally shaped rigid carrier part after the introduction of the depressions and before the filling of the depressions with metal paste. Before being attached to the carrier part, the wood veneer can be trimmed while flat to match the desired configuration in the three-dimensional state. Particularly when the wood veneer is applied to an outer side of a curved region of the carrier part, the depressions can bend open somewhat, as a result of which the holding volume for the metal paste can increase. Since the metal paste is applied only in the bent state of the wood veneer, it is possible to avoid a situation where metal paste is squeezed out of a depression and/or flakes off an edge of a depression. It is thereby possible to ensure a level surface configuration of the decorative part.

After the removal of the metal paste, the surface of the decorative part can be machined, in particular polished, at least locally, preferably over the entire surface. This makes it possible to adjust the gloss of the hardened metal paste in the depressions and/or of the wood veneer in the intermediate regions to the desired degree. In particular, the decorative part can have a protective layer, e.g. a clear lacquer, which forms the outer side of the decorative part. The protective layer can protect the wooden decorative element, the hardened metal paste and, if required, the separating coat from external influences, e.g. shocks and/or moisture.

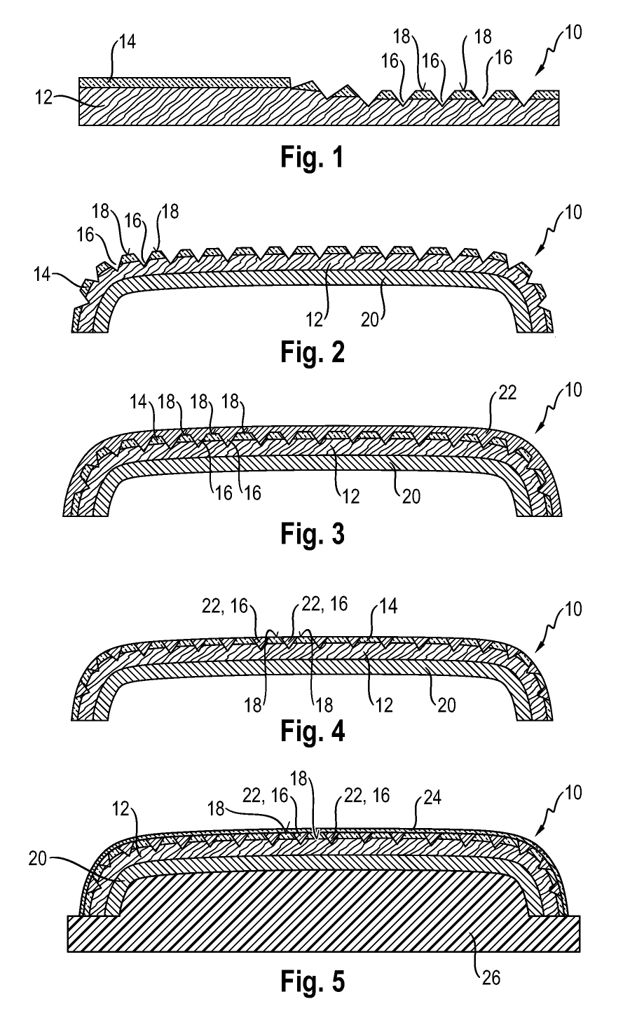

At the beginning of production, the decorative part 10 illustrated in FIG. 1 is in the form of a wood veneer 12, which is coated with a colored or transparent separating coat 14 on its upper side, which is visible in the installed state. In the production step illustrated in FIG. 1, the wood veneer 12 is exposed to a stamping roll, which introduces depressions 16 into the wood veneer 12 from the upper side of the wood veneer 12 and simultaneously compresses the wood veneer 12. During this process, the stamping roll can dig into the wood veneer 12 coated with the separating coat 14 to such an extent to produce the depressions 16 that the separating coat 14 is penetrated in the region of the depressions 16. In intermediate regions 18 situated between the depressions 16, the separating coat 14 remains intact.

The decorative part 10 present after this production step can then be suitably trimmed and three-dimensionally shaped. For this purpose, the wood veneer 12 can be joined to a three-dimensionally shaped carrier part 20, as illustrated in FIG. 2. The three-dimensional shaping of the decorative part 10 can lead to a change in the holding volume of the depressions 16 provided in the bent wood veneer 12.

A metal paste 22 can then be applied to the decorative part 10, as illustrated in FIG. 3. The metal paste 22 can completely fill the depressions 16.

The layer thickness of the metal paste is preferably such that not only are the depressions 16 completely filled but the intermediate regions 18 are also covered.

The metal paste 22 can then harden, for example. As illustrated in FIG. 4, the metal paste 22 can be partially removed, e.g. by machining. In particular, the metal paste 22 can be removed down to a layer thickness at which the separating coat 14 has been completely or partially removed in the intermediate regions 18. In particular, it is possible, for example, for the gloss level of the metal paste remaining in the depressions 16 and/or of the intermediate regions 18 to be adjusted by means of a polishing step.

As illustrated in FIG. 5, the decorative part 10 can furthermore be provided on the upper side thereof with a protective layer 24, in particular a transparent protective layer, in particular a clear lacquer. A substrate body 26 is preferably provided on a lower side of the carrier part 20, said substrate body being produced, in particular, from a plastic, e.g. PUR, and imparting to the decorative part 10 a desired defined shape, which makes it easier to install the decorative part 10 in an interior trim of a motor vehicle. The carrier part 20 is preferably fully enclosed by the wood veneer 12 and the substrate body 26.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A decorative part for an interior trim of a motor vehicle, the decorative part comprising:
a wood veneer, wherein the wood veneer has depressions filled with a hardened metal paste, wherein the hardened metal paste is provided exclusively in the depressions.

2. The decorative part as claimed in claim 1, wherein the hardened metal paste is configured in such a way that the surface thereof is flush with an intermediate region, provided between the depressions, of the wood veneer.

3. The decorative part as claimed in claim 1, wherein the wood veneer has a separating coat for the removal of metal paste from the wood veneer in an intermediate region provided between the depressions.

4. The decorative part as claimed in claim 1, wherein the wood veneer is compressed.

5. The decorative part as claimed in claim 1, wherein the wood veneer is joined to a three-dimensionally shaped rigid carrier part.

6. A method for producing a decorative part, the method comprising:
introducing depressions into a wood veneer,
completely filling the depressions with a metal paste,
removing excess metal paste outside the depressions, and
hardening the metal paste filling the depressions.

7. The method as claimed in claim 6, wherein the depressions are introduced by stamping, and wherein the wood veneer is compressed to a smaller material thickness during stamping.

8. The method as claimed in claim 6, wherein the wood veneer is coated with a separating coat for the removal of metal paste from the wood veneer before the depressions are introduced, wherein the separating coat is penetrated in the region of the depressions as the depressions are introduced.

9. The method as claimed in claim 8, wherein the separating coat is completely or partially removed in an intermediate region provided between the depressions during the removal of the excess metal paste.

10. The method as claimed in claim 6, wherein the wood veneer is joined to a three-dimensionally shaped rigid carrier part after the introduction of the depressions and before the filling of the depressions with metal paste.

11. The decorative part as claimed in claim 1, wherein the depressions are stamped depressions.
